(19) United States
(12) Patent Application Publication
(10) Pub. No.: US 2018/0282974 A1
(43) Pub. Date: Oct. 4, 2018

(54) FLUID PRESSURE CONTROL DEVICE

(71) Applicant: KYB Corporation, Tokyo (JP)

(72) Inventors: Shunsuke KUBO, Gifu (JP); Jun KIMURA, Gifu (JP)

(73) Assignee: KYB Corporation, Tokyo (JP)

(21) Appl. No.: 15/762,641

(22) PCT Filed: Sep. 21, 2016
(86) PCT No.: PCT/JP2016/077842

§ 371 Date: Mar. 23, 2018

(30) Foreign Application Priority Data
Sep. 25, 2015 (JP) 2015-188453
Aug. 3, 2016 (JP) 2016-153158

(51) Int. Cl. E02F 9/22; F15B 13/02

(52) U.S. Cl. CPC E02F 9/2225; E02F 9/2267; F15B 11/15; F15B 13/024; F15B 13/027; E02F 9/2285

(57) ABSTRACT

A fluid pressure control device includes a switching valve configured to switch an operation of an operate check valve, a relief valve configured to open when a pressure in a load-side pressure chamber reaches a predetermined pressure, and a relief discharge passage configured to lead a relief fluid discharged from the relief valve to a tank. The switching valve includes a piston giving thrust to a spool upon receipt of a pilot pressure on a back surface, a drain chamber defined by the spool and the piston, and a drain passage allowing the drain chamber and a spring chamber to communicate with the relief discharge passage. The relief fluid discharged from the relief valve is discharged to the tank through the relief discharge passage and does not operate the switching valve.

### TECHNICAL FIELD

The present invention relates to a fluid pressure control device for controlling an operation of a hydraulic operating apparatus.

### BACKGROUND ART

JP2000-220603A discloses a hydraulic control device controlling an operation of a hydraulic operating apparatus, which includes a cylinder device, a control valve controlling an extension and contraction operation of the cylinder device, and a load holding valve provided between the cylinder device and the control valve. The load holding valve includes a pilot check valve, a switching valve cancelling a check function of the pilot check valve, and a relief valve opening the valve when a load pressure in a bottom-side pressure chamber of the cylinder device increases.

The switching valve includes a pilot chamber to which a pilot pressure is led and a spool moved by a pilot pressure of the pilot chamber. An end portion of the spool is not directly faced the pilot chamber but an end portion of a sub spool provided adjacent to the spool is faced the pilot chamber.

When the load pressure in the bottom-side pressure chamber of the cylinder device increases, and the relief valve is opened, a relief back pressure is generated on an upstream side of an orifice provided on a downstream of the relief valve, and the relief back pressure is led to a space between the spool and the sub spool in the pilot chamber of the switching valve. As a result, the spool is moved, the switching valve is switched, and the check function of the pilot check valve is cancelled, whereby the pressure in the bottom-side pressure chamber is lowered.

### SUMMARY OF INVENTION

In the hydraulic control device disclosed in JP2000-220603A, when the cylinder device is contracted, an operator of the hydraulic excavator manually operates an operation lever, and the pilot pressure is led to the pilot chamber of the switching valve. The pilot pressure acts on the sub spool, and the sub spool applies a thrust to the spool, whereby the spool is opened, and the check function of the pilot check valve is cancelled, and the cylinder device is contracted. On the other hand, when the load pressure in the bottom-side pressure chamber of the cylinder device increases and the relief valve is opened, the relief back pressure generated on the upstream side of the orifice provided on the downstream of the relief valve is led to the space between the spool and the sub spool and acts on the spool, whereby the thrust is given to the spool. As described above, when the pilot pressure is led to the pilot chamber by the operator's operation so as to move the spool, the thrust is given to the spool through the sub spool, while when the relief valve is opened, the relief back pressure directly acts on the spool.

Here, in a state where the pilot pressure has been led to the pilot chamber by the operator's operation and the spool is open, if the relief valve is opened, since the relief back pressure is led to the space between the spool and the sub spool, the sub spool is moved to a side opposite to the spool, and the thrust by the pilot pressure is not easily transmitted from the sub spool to the spool. Moreover, if a pressure receiving area of the spool on which the relief back pressure acts is smaller than the pressure receiving area of the sub spool, the spool may be sometimes moved to a closing direction depending on the relief back pressure.

Therefore, if the relief valve is opened while the operation lever is being operated by the operator in order to contract the cylinder device, the spool is moved to the closing direction, and a situation can occur that a contracting speed of the cylinder device intended by the operator cannot be obtained.

The present invention has an object to provide a fluid pressure control device which enables a stable operation of a cylinder.

According to one aspect of the present invention, a fluid pressure control device for controlling an extension and contraction operation of a cylinder driving a load includes: a control valve configured to control supply of an operating fluid from a fluid pressure supply source to the cylinder; a pilot control valve configured to control a pilot pressure led from a pilot pressure supply source to the control valve; a main passage connecting a load-side pressure chamber of the cylinder on which a load pressure by a load acts when the control valve is at a neutral position and the control valve; and a load holding mechanism provided in the main passage. The load holding mechanism includes: an operate check valve configured to allow a flow of the operating fluid from the control valve to the load-side pressure chamber, while allow the flow of the operating fluid from the load-side pressure chamber to the control valve in accordance with a back pressure; a switching valve configured to be operated in conjunction with the control valve by the pilot pressure led through the pilot control valve so as to switch an operation of the operate check valve; a relief valve configured to open when a pressure in the load-side pressure chamber reaches a predetermined pressure; and a relief discharge passage configured to lead a relief fluid discharged from the relief valve to a tank. The switching valve includes: a pilot chamber to which the pilot pressure is led through the pilot control valve; a spool moved in accordance with the pilot pressure of the pilot chamber; a spring chamber accommodating an biasing member biasing the spool in a valve closing direction; a piston giving thrust against an biasing force of the biasing member to the spool upon receipt of the pilot pressure on a back surface; a drain chamber defined by the spool and the piston; and a drain passage configured to allow the drain chamber and the spring chamber to communicate with the relief discharge passage. The relief fluid discharged from the relief valve is discharged to the tank through the relief discharge passage and does not operate the switching valve.

### BRIEF DESCRIPTION OF DRAWINGS

FIG. 1 is a view showing a part of a hydraulic excavator;

FIG. 2 is a hydraulic circuit diagram of a fluid pressure control device according to a first embodiment of the present invention;

FIG. 3 is a sectional view of a load holding mechanism of the fluid pressure control device according to the first embodiment of the present invention;

FIG. 4 is a plan view of the load holding mechanism of the fluid pressure control device according to the first embodiment of the present invention;

FIG. 5 is a hydraulic circuit diagram of the fluid pressure control device according to a first variation of the first embodiment of the present invention;

FIG. 6 is a hydraulic circuit diagram of the fluid pressure control device according to a second variation of the first embodiment of the present invention;

FIG. 7 is a hydraulic circuit diagram of the fluid pressure control device according to a third variation of the first embodiment of the present invention;

FIG. 8 is a hydraulic circuit diagram of the fluid pressure control device according to a fourth variation of the first embodiment of the present invention;

FIG. 9 is a hydraulic circuit diagram of a fluid pressure control device according to a second embodiment of the present invention;

FIG. 10 is a sectional view of a load holding mechanism of the fluid pressure control device according to the second embodiment of the present invention;

FIG. 11 is an enlarged sectional view of an A part in FIG. 10;

FIG. 12 is a sectional view of a load holding mechanism of the fluid pressure control device according to a fifth variation of the second embodiment of the present invention;

FIG. 13 is a hydraulic circuit diagram of the fluid pressure control device according to a sixth variation of the second embodiment of the present invention;

FIG. 14 is a plan view of a load holding mechanism of the fluid pressure control device according to a sixth variation of the second embodiment of the present invention;

FIG. 15 is a hydraulic circuit diagram showing a comparative example of the first embodiment of the present invention; and

FIG. 16 is a sectional view showing the comparative example of the first embodiment of the present invention.

### DESCRIPTION OF EMBODIMENTS

A fluid pressure control device according to embodiments of the present invention will be described by referring to the attached drawings.

### First Embodiment

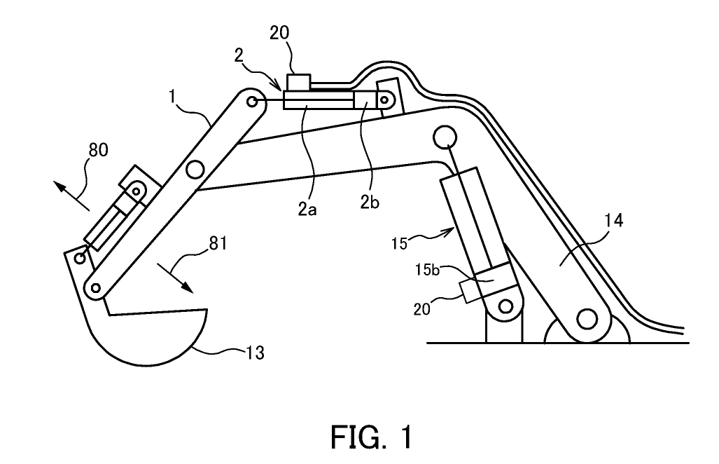

By referring to FIGS. 1 to 10, a fluid pressure control device according to a first embodiment will be described. The fluid pressure control device is to control an operation of a hydraulic working apparatus such as a hydraulic excavator, and in this embodiment, a hydraulic control device controlling an extension and contraction operation of a cylinder 2 driving an arm (load) 1 of a hydraulic excavator illustrated in FIG. 1 will be described.

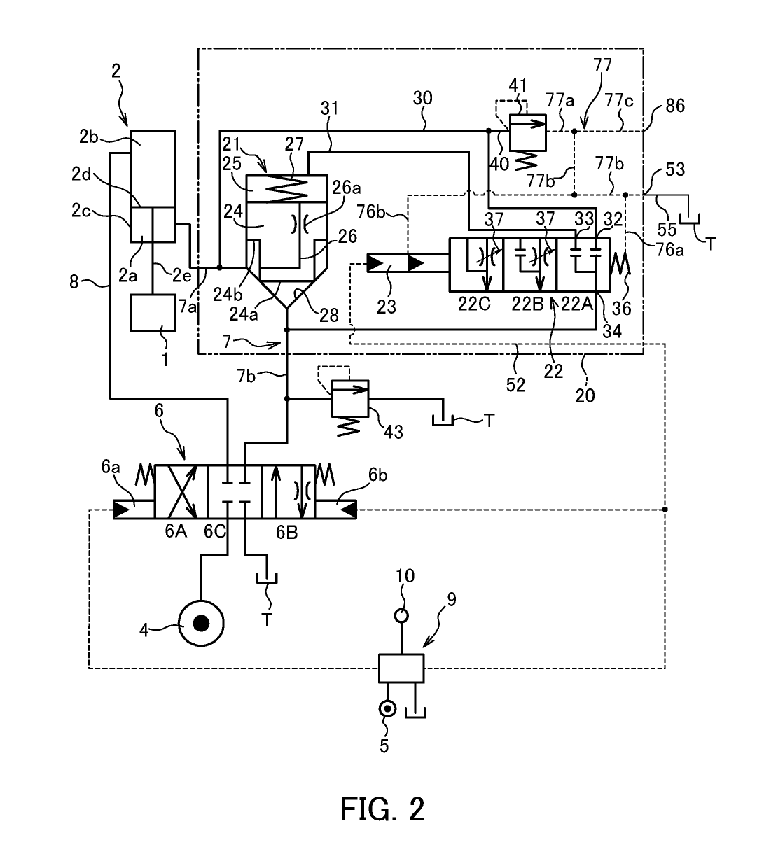

First, a hydraulic circuit of the hydraulic control device will be described by referring to FIG. 2.

The cylinder 2 includes a cylindrical cylinder tube 2c, a piston 2d slidably inserted into the cylinder tube 2c and dividing an inside of the cylinder tube 2c into a rod-side chamber 2a and an anti-rod side chamber 2b, and a rod 2e having one end connected to the piston 2d and the other end side extending to an outside of the cylinder tube 2c and connected to the arm 1.

An engine is mounted on the hydraulic excavator, and a power of the engine drives a pump 4 as a fluid pressure supply source and a pilot pump 5 as a pilot pressure supply source.

The hydraulic control device includes a control valve 6 controlling supply of an operating oil from the pump 4 to the cylinder 2 and a pilot control valve 9 controlling a pilot pressure led from the pilot pump 5 to the control valve 6.

The control valve 6 and the rod-side chamber 2a of the cylinder 2 are connected by a first main passage 7, and the control valve 6 and the anti-rod side chamber 2b of the cylinder 2 are connected by a second main passage 8.

The control valve 6 is operated by the pilot pressure led from the pilot pump 5 to the pilot chambers 6a and 6b through the pilot control valve 9 with a manual operation of an operation lever 10 by an operator of the hydraulic excavator.

Specifically, when the pilot pressure is led to the pilot chamber 6a, the control valve 6 is switched to a position 6A, the operating oil is supplied from the pump 4 to the rod-side chamber 2a through the first main passage 7, and the operating oil in the anti-rod side chamber 2b is discharged to a tank T through the second main passage 8. As a result, the cylinder 2 is contracted, and the arm 1 is raised to a direction of an arrow 80 illustrated in FIG. 1.

On the other hand, when the pilot pressure is let to the pilot chamber 6b, the control valve 6 is switched to a position 6B, the operating oil is supplied from the pump 4 to the anti-rod side chamber 2b through the second main passage 8, and the operating oil in the rod-side chamber 2a is discharged to the tank T through the first main passage 7. As a result, the cylinder 2 is extended, and the arm 1 is lowered to a direction of an arrow 81 illustrated in FIG. 1.

When the pilot pressure is not led to the pilot chambers 6a and 6b, the control valve 6 is at a position 6C, supply and discharge of the operating oil with respect to the cylinder 2 is shut off, and the arm 1 holds a stopped state.

As described above, the control valve 6 has three positions, that is, the contracted position 6A where the cylinder 2 is contracted, the extended position 6B where the cylinder 2 is extended, and the neutral position 6C where the load of the cylinder 2 is held, switches supply and discharge of the operating oil with respect to the cylinder 2 and controls the extension and contraction operation of the cylinder 2.

Here, as illustrated in FIG. 1, if the control valve 6 is switched to the neutral position 6C and a motion of the arm 1 is stopped in a state where a bucket 13 is lifted up, a force in a direction of extending acts on the cylinder 2 by self-weights of the bucket 13, the arm 1 and the like. As described above, in the cylinder 2 driving the arm 1, the rod-side chamber 2a becomes a load-side pressure chamber on which a load pressure acts when the control valve 6 is at the neutral position 6C.

In the first main passage 7 connected to the rod-side chamber 2a which is the load-side pressure chamber, a load holding mechanism 20 is provided. The load holding mechanism 20 is to hold a load pressure of the rod-side chamber 2a when the control valve 6 is at the neutral position 6C and is fixed to a surface of the cylinder 2 as illustrated in FIG. 1.

In a cylinder 15 for driving a boom 14, an anti-rod side chamber 15b becomes a load-side pressure chamber and thus, when the load holding mechanism 20 is provided on the boom 14, the load holding mechanism 20 is provided in the main passage connected to the anti-rod side chamber 15b (see FIG. 1).

The load holding mechanism 20 includes an operate check valve 21 provided in the first main passage 7 and a switching valve 22 operated in conjunction with the control valve 6 by the pilot pressure led to the pilot chamber 23 through the pilot control valve 9 and switching an operation of the operate check valve 21.

The operate check valve 21 includes a valve body 24 opening and closing the first main passage 7, a seat portion 28 on which the valve body 24 is seated, a back pressure chamber 25 defined on a back surface of the valve body 24, and a passage 26 formed on the valve body 24 and leading the operating oil in the rod-side chamber 2a to the back pressure chamber 25 at all times. A throttle 26a is provided on the passage 26.

The first main passage 7 has a cylinder-side first main passage 7a connecting the rod-side chamber 2a and the operate check valve 21 and a control-valve side first main passage 7b connecting the operate check valve 21 and the control valve 6.

On the valve body 24, a first pressure receiving surface 24a on which a pressure of the control-valve side first main passage 7b acts and a second pressure receiving surface 24b on which a pressure of the rod-side chamber 2a acts through the cylinder-side first main passage 7a are formed.

In the back pressure chamber 25, a spring 27 as a biasing member for biasing the valve body 24 to a valve closing direction is housed. The pressure of the back pressure chamber 25 and the biasing force of the spring 27 act in a direction causing the valve body 24 to be seated on the seat portion 28.

In a state where the valve body 24 is seated on the seat portion 28, the operate check valve 21 exerts a function as a check valve that shuts off a flow of the operating oil from the rod-side chamber 2a to the control valve 6. That is, the operate check valve 21 holds a load pressure by preventing leakage of the operating oil in the rod-side chamber 2a and holds a stopped state of the arm 1.

The load holding mechanism 20 further includes a bypass passage 30 for leading the operating oil in the rod-side chamber 2a to the control-valve side first main passage 7b by bypassing the operate check valve 21 and a back pressure passage 31 for leading the operating oil in the back pressure chamber 25 to the control-valve side first main passage 7b.

The switching valve 22 is provided in the bypass passage 30 and the back pressure passage 31 and switches communication of the bypass passage 30 and the backpressure passage 31 with respect to the control-valve side first main passage 7b and controls the flow of the operating oil in the first main passage 7 which becomes a meter-out side when the cylinder 2 is extended.

The switching valve 22 has three ports, that is, a first supply port 32 communicating with the bypass passage 30, a second supply port 33 communicating with the back pressure passage 31, and a discharge port 34 communicating with the control-valve side first main passage 7b. Moreover, the switching valve 22 has three positions, that is, a shut-off position 22A, a first communication position 22b, and a second communication position 22c.

When the pilot pressure is led to the pilot chamber 6b of the control valve 6, the same pilot pressure is led to the pilot chamber 23 at the same time. That is, when the control valve 6 is switched to the extended position 6B, the switching valve 22 is also switched to the first communication position 22B or the second communication position 22C.

Specifically explaining, when the pilot pressure is not led to the pilot chamber 23, the switching valve 22 holds the shut-off position 22A by the biasing force of the spring 36. At the shut-off position 22A, both the first supply port 32 and the second supply port 33 are shut off.

When the pilot pressure not smaller than a first predetermined pressure and less than a second predetermined pressure is led to the pilot chamber 23, the switching valve 22 is switched to the first communication position 22B. At the first communication position 22B, the first supply port 32 communicates with the discharge port 34. As a result, the operating oil in the rod-side chamber 2a is led from the bypass passage 30 to the control-valve side first main passage 7b through the switching valve 22. That is, the operating oil in the rod-side chamber 2a bypasses the operate check valve 21 and is led to the control-valve side first main passage 7b. At this time, resistance is applied to the flow of the operating oil by the throttle 37. The second supply port 33 holds the shut-off state.

When the pilot pressure not smaller than the second predetermined pressure is led to the pilot chamber 23, the switching valve 22 is switched to the second communication position 22C. At the second communication position 22C, the first supply port 32 communicates with the discharge port 34, and the second supply port 33 also communicates with the discharge port 34. As a result, the operating oil in the back pressure chamber 25 is led from the back pressure passage 31 to the control-valve side first main passage 7b through the switching valve 22. At this time, the operating oil in the back pressure chamber 25 bypasses the throttle 37 and is led to the control-valve side first main passage 7b and is discharged to the tank T from the control valve 6. As a result, a differential pressure is generated between before and after the throttle 26a, and a pressure in the back pressure chamber 25 becomes small and thus, a force in the valve closing direction acting on the valve body 24 becomes smaller, the valve body 24 is separated from the seat portion 28, and the function as a check valve of the operate check valve 21 is cancelled.

On the upstream of the switching valve 22 in the bypass passage 30, a relief passage 40 branches and is connected. On the relief passage 40, a relief valve 41 allowing passage of the operating oil by opening the valve and causing the operating oil in the rod-side chamber 2a to escape when the pressure in the rod-side chamber 2a reaches a predetermined pressure is provided. The relief pressure oil (relief fluid) discharged from the relief valve 41 is discharged to the tank T through a relief discharge passage 77 connecting the relief valve 41 and the tank T.

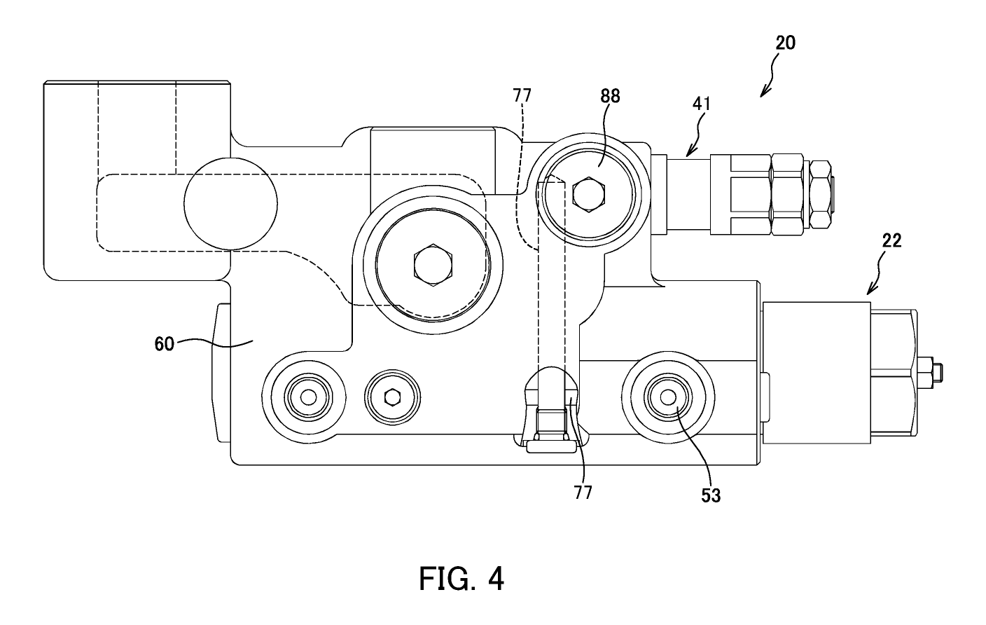

The relief discharge passage 77 has a main discharge passage 77a connected to the relief valve 41 and a first branch passage 77b and a second branch passage 77c branching into two passages from the main discharge passage 77a. The first branch passage 77b is connected to a first drain port 53, and the second branch passage 77c is connected to a second drain port 86. The first drain port 53 and the second drain port 86 are open in an outer surface of a body 60 which will be described later, respectively. The first drain port 53 has a diameter smaller than the second drain port 86 and is constituted connectable to a pipeline with a smaller diameter. In this embodiment, a pipeline 55 communicating with the tank T is connected to the first drain port 53, and the second drain port 86 is sealed by a plug 88 (see FIG. 4). Thus, in this embodiment, a relief pressure oil discharged from the relief valve 41 is led to the pipeline 55 through the main discharge passage 77a, the first branch passage 77b, and the first drain port 53 and is discharged to the tank T.

To the control-valve side first main passage 7b, a relief valve 43 opened when the pressure in the control-valve side first main passage 7b reaches the predetermined pressure is connected.

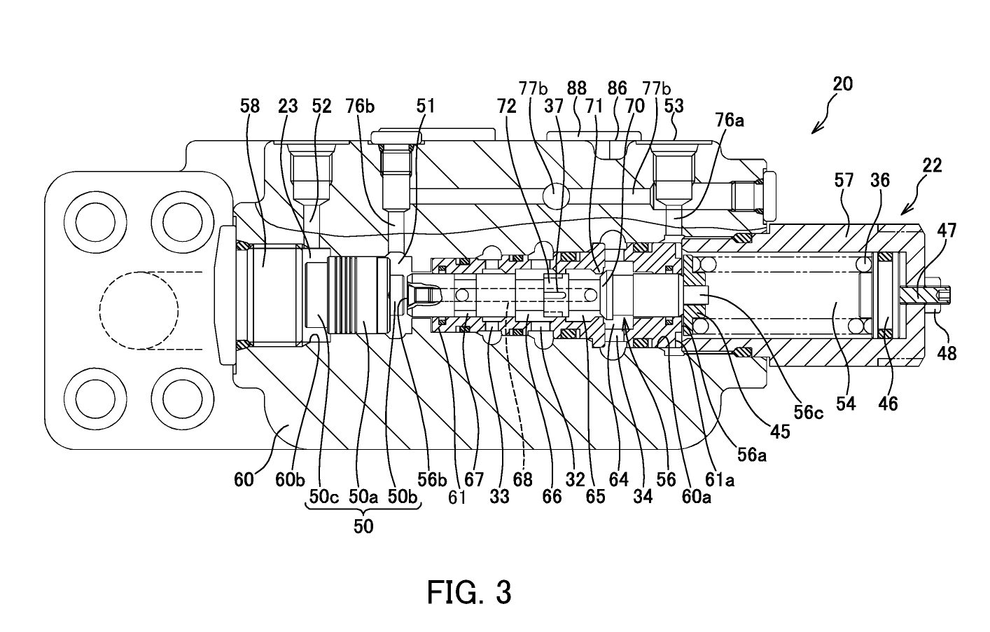

Subsequently, the switching valve 22 will be described in detail by referring mainly to FIGS. 3 and 4. FIG. 3 is a sectional view of the load holding mechanism 20 and illustrates a state where the pilot pressure is not led to the pilot chamber 23 and the switching valve 22 is at the shut-off position 22A. FIG. 4 is a plan view of the load holding mechanism 20. In FIGS. 3 and 4, the same constitutions as the constitutions shown in FIG. 2 are shown by the same reference numerals as FIG. 2.

As illustrated in FIG. 3, the switching valve 22 is incorporated in the body 60. A spool hole 60a is formed in the body 60, and a substantially cylindrical sleeve 61 is inserted into the spool hole 60a. A spool 56 is slidably incorporated in the sleeve 61.

A spring chamber 54 is defined by a cap 57 on a side of one end surface 56a of the spool 56. The spring chamber 54 is connected to a first drain passage 76a through a notch 61a formed on an end surface of the sleeve 61. The first drain passage 76a is connected to the first branch passage 77b of the relief discharge passage 77. Therefore, the operating oil leaking into the spring chamber 54 is discharged to the tank T through the first drain passage 76a and the first branch passage 77b.

In the spring chamber 54, the spring 36 as the biasing member for biasing the spool 56 is accommodated. Moreover, in the spring chamber 54, an annular first spring receiving member 45 having an end surface brought into contact with the one end surface 56a of the spool 56 and having a pin portion 56c formed by protruding on the one end surface 56a of the spool 56 inserted in a hollow part and a second spring receiving member 46 arranged in the vicinity of a bottom portion of the cap 57 are housed. The spring 36 is fitted in a compressed state between the first spring receiving member 45 and the second spring receiving member 46 and biases the spool 56 to the valve closing direction through the first spring receiving member 45.

An axial position of the second spring receiving member 46 in the spring chamber 54 is set by a distal end portion of an adjusting bolt 47 penetrated into and screwed with the bottom portion of the cap 57 brought into contact with a back surface of the second spring receiving member 46. By screwing the adjusting bolt 47, the second spring receiving member 46 is moved to the direction getting closer to the first spring receiving member 45. Therefore, by adjusting a screwing amount of the adjusting bolt 47, an initial spring load of the spring 36 can be adjusted. The adjusting bolt 47 is fixed by a nut 48.

On a side of the other end surface 56b of the spool 56, the pilot chamber 23 is defined by a piston hole 60b formed by communicating with the spool hole 60a and a cap 58 closing the piston hole 60b. A pilot pressure is led to the pilot chamber 23 through a pilot passage 52 formed in the body 60. A piston 50 for giving a thrust to the spool 56 upon receipt of the pilot pressure on the back surface against the biasing force of the spring 36 is slidably accommodated in the pilot chamber 23.

In the piston hole 60b, a drain chamber 51 is defined by the spool 56 and the piston 50. The drain chamber 51 is connected to a second drain passage 76b, and the second drain passage 76b is connected to the first branch passage 77b of the relief discharge passage 77. Therefore, the operating oil leaking into the drain chamber 51 is discharged to the tank T through the second drain passage 76b and the first branch passage 77b.

The piston 50 includes a sliding portion 50a whose outer peripheral surface slides along an inner peripheral surface of the piston hole 60b, a distal end portion 50b formed having a diameter smaller than the sliding portion 50a and opposed to the other end surface 56b of the spool 56, and a base end portion 50c formed having a diameter smaller than the sliding portion 50a and opposed to a distal end surface of the cap 58.

When the pilot pressure oil is supplied into the pilot chamber 23 through the pilot passage 52, the pilot pressure acts on the back surface of a base end portion 50c and an annular back surface of the sliding portion 50a. As a result, the piston 50 is advanced, and the distal end portion 50b is brought into contact with the other end surface 56b of the spool 56 and moves the spool 56. As described above, the spool 56 receives the thrust of the piston 50 generated on the basis of the pilot pressure acting on the back surface of the piston 50 and is moved against the biasing force of the spring 36. Even if the back surface of the base end portion 50c is in contact with the distal end surface of the cap 58, since the diameter of the base end portion 50c is smaller than that of the sliding portion 50a and the pilot pressure acts on the annular back surface of the sliding portion 50a, the piston 50 is capable of advancing.

Since one end portion of the piston 50 is faced with the pilot chamber 23 and the other end portion is faced with the drain chamber 51 connected to the tank T, the thrust of the piston 50 generated on the basis of the pilot pressure in the pilot chamber 23 is efficiently transmitted to the spool 56.

Each of the drain chamber 51 and the spring chamber 54 communicates with the first branch passage 77b of the relief discharge passage 77 through the first drain passage 76a and the second drain passage 76b. The first branch passage 77b is formed by communicating with the first drain port 53 opened in the outer surface of the body 60. The first drain port 53 is connected to the tank T through the pipeline 55 (see FIG. 2). Since the drain chamber 51 and the spring chamber 54 both communicate with the tank T, when the switching valve 22 is at the shut-off position 22A, an atmospheric pressure acts on both ends of the spool 56, and such a situation that the spool 56 is moved unintentionally is prevented.

As described above, the relief pressure oil discharged from the relief valve 41 and the drain of the drain chamber 51 and the spring chamber 54 are merged and discharged to the tank T through the first drain port 53 and the pipeline 55.

The spool 56 is stopped at a position where the biasing force of the spring 36 acting on the one end surface 56a is balanced with the thrust of the piston 50 acting on the other end surface 56b, and the switching position of the switching valve 22 is set at the stop position of the spool 56.

On the sleeve 61, three ports, that is, the first supply port 32 communicating with the bypass passage 30 (see FIG. 2), the second supply port 33 communicating with the back pressure passage 31 (see FIG. 2), and the discharge port 34 communicating with the control-valve side first main passage 7b are formed.

The outer peripheral surface of the spool 56 is partially notched annularly, and the notched portion and the inner peripheral surface of the sleeve 61 form a first pressure chamber 64, a second pressure chamber 65, a third pressure chamber 66, and a fourth pressure chamber 67.

The first pressure chamber 64 communicates with the discharge port 34 at all times.

The third pressure chamber 66 communicates with the first supply port 32 at all times. On an outer periphery of a land portion 72 of the spool 56, a plurality of throttles 37 allowing the third pressure chamber 66 and the second pressure chamber 65 to communicate with each other are formed by movement of the spool 56 against the biasing force of the spring 36.

The fourth pressure chamber 67 communicates with the second pressure chamber 65 at all times through a pressure leading passage 68 formed in the axial direction in the spool 56.

When the pilot pressure is not led to the pilot chamber 23, a poppet valve 70 formed on the spool 56 by the biasing force of the spring 36 is pressed onto a valve seat 71 formed on an inner periphery of the sleeve 61, and the communication between the second pressure chamber 65 and the first pressure chamber 64 is shut off. Therefore, the communication between the first supply port 32 and the discharge port 34 is shut off. As a result, the operating oil in the rod-side chamber 2a does not leak to the discharge port 34. This state corresponds to the shut-off position 22A of the switching valve 22. In a state where the poppet valve 70 is seated on the valve seat 71 by the biasing force of the spring 36, since a slight gap is present between the end surface of the first spring receiving member 45 and the end surface of the sleeve 61, the poppet valve 70 is reliably seated on the valve seat 71 by the biasing force of the spring 36.

When the pilot pressure is led to the pilot chamber 23 and the thrust of the piston 50 acting on the spool 56 becomes larger than the biasing force of the spring 36, the spool 56 is moved against the biasing force of the spring 36. As a result, the poppet valve 70 is separated from the valve seat 71, and the third pressure chamber 66 and the second pressure chamber 65 communicate with each other through the plurality of throttles 37 and thus, the first supply port 32 communicates with the discharge port 34 through the third pressure chamber 66, the second pressure chamber 65, and the first pressure chamber 64. By means of the communication between the first supply port 32 and the discharge port 34, the operating oil in the rod-side chamber 2a is led to the control-valve side first main passage 7b through the throttle 37. This state corresponds to the first communication position 22B of the switching valve 22.

When the pilot pressure led to the pilot chamber 23 becomes larger, the spool 56 is further moved against the biasing force of the spring 36, and the second supply port 33 communicates with the fourth pressure chamber 67. As a result, the second supply port 33 communicates with the discharge port 34 through the fourth pressure chamber 67, the pressure leading passage 68, the second pressure chamber 65, and the first pressure chamber 64. By means of the communication between the second supply port 33 and the discharge port 34, the operating oil in the back pressure chamber 25 is led to the control-valve side first main passage 7b. This state corresponds to the second communication position 22C of the switching valve 22.

Subsequently, an operation of the hydraulic control device will be described by referring mainly to FIGS. 2 and 3.

When the control valve 6 is at the neutral position 6C, the operating oil discharged by the pump 4 is not supplied to the cylinder 2. At this time, since the pilot pressure is not led to the pilot chamber 23 of the switching valve 22, the switching valve 22 is also brought into the state at the shut-off position 22A.

Thus, the back pressure chamber 25 of the operate check valve 21 is maintained at a pressure of the rod-side chamber 2a. Here, since the pressure receiving area (area of the back surface of the valve body 24) in the valve body 24 in the valve closing direction is larger than the area of the second pressure receiving surface 24b which is the pressure receiving area in the valve opening direction, the valve body 24 is brought into the state seated on the seat portion 28 by the load by the pressure of the back pressure chamber 25 acting on the back surface of the valve body 24 and the biasing force of the spring 27. As described above, the leakage of the operating oil in the rod-side chamber 2a is prevented by the operate check valve 21, and the stopped state of the arm 1 is held.

When the operation lever 10 is operated and the pilot pressure is led from the pilot control valve 9 to the pilot chamber 6a of the control valve 6, the control valve 6 is switched to the contracted position 6A by an amount according to the pilot pressure. When the control valve 6 is switched to the contracted position 6A, an ejection pressure of the pump 4 acts on the first pressure receiving surface 24a of the operate check valve 21. At this time, since the pilot pressure is not led to the pilot chamber 23 and the switching valve 22 is in the state of the shut-off position 22A, the back pressure chamber 25 of the operate check valve 21 is maintained at the pressure of the rod-side chamber 2a. When the load acting on the first pressure receiving surface 24a becomes larger than a total load of the load acting on the back surface of the valve body 24 by the pressure of the back pressure chamber 25 and the biasing force of the spring 27, the valve body 24 is separated from the seat portion 28. When the operate check valve 21 is opened as above, the operating oil ejected from the pump 4 is supplied to the rod-side chamber 2a, and the cylinder 2 is contracted. As a result, the arm 1 is raised to the direction of the arrow 80 illustrated in FIG. 1.

When the operation lever 10 is operated and the pilot pressure is led from the pilot control valve 9 to the pilot chamber 6b of the control valve 6, the control valve 6 is switched to the extended position 6B only for an amount according to the pilot pressure. At the same time, since the pilot pressure is led also to the pilot chamber 23, the switching valve 22 is switched to the first communication position 22B or the second communication position 22C in accordance with the supplied pilot pressure.

When the pilot pressure led to the pilot chamber 23 is not smaller than a first predetermined pressure and less than a second predetermined pressure, the switching valve 22 is switched to the first communication position 22B. In this case, since the communication between the second supply port 33 and the discharge port 34 is in the shut-off state, the back pressure chamber 25 of the operate check valve 21 is maintained at the pressure of the rod-side chamber 2a, and the operate check valve 21 is brought into the closed valve state.

On the other hand, since the first supply port 32 communicates with the discharge port 34, the operating oil of the rod-side chamber 2a passes through the throttle 37 from the bypass passage 30 and is led to the control-valve side first main passage 7b and is discharged to the tank T from the control valve 6. Moreover, since the operating oil ejected from the pump 4 is supplied to the anti-rod side chamber 2b, the cylinder 2 is extended. As a result, the arm 1 is lowered to the direction of the arrow 81 illustrated in FIG. 1.

Here, the switching valve 22 is switched to the first communication position 22B in a case where a crane operation for lowering a conveyed article mounted on the bucket 13 to a target position or a horizontal drawing operation for horizontally moving the bucket 13 by moving the arm 1 and the boom 14 at the same time are performed. In the crane operation, since the arm 1 needs to be slowly lowered to the direction of the arrow 81 by extending the cylinder 2 at a low speed, the control valve 6 is only switched to the extended position 6B slightly. Moreover, since the horizontal drawing operation is a difficult work of moving the arm 1 and the boom 14 at the same time so that the bucket 13 is moved horizontally, the arm 1 and the boom 14 are moved slowly. Thus, in the horizontal drawing operation, too, the control valve 6 is only switched to the extended position 6B slightly. Thus, the pilot pressure led to the pilot chamber 6b of the control valve 6 is small, the pilot pressure led to the pilot chamber 23 of the switching valve 22 is not smaller than the first predetermined pressure and less than the second predetermined pressure, and the switching valve 22 is switched only to the first communication position 22B. Therefore, the operating oil in the rod-side chamber 2a passes through the throttle 37 and is discharged, and the arm 1 is moved at a low speed suitable for the crane operation or the horizontal drawing operation.

Moreover, when the switching valve 22 is at the first communication position 22B, even if such a state occurs that the control-valve side first main passage 7b is ruptured or the like and the operating oil leaks out to the outside, since a flow rate of the operating oil discharged from the rod-side chamber 2a is limited by the throttle 37, the falling speed of the bucket 13 is suppressed. This function is called metering control. Thus, before the bucket 13 falls onto the ground, the switching valve 22 can be switched to the shut-off position 22A, and a sudden fall of the bucket 13 can be prevented.

As described above, the throttle 37 is to suppress a lowering speed of the cylinder 2 in valve closing of the operate check valve 21 and is to suppress a falling speed of the bucket 13 in rupture of the control-valve side first main passage 7b.

When the pilot pressure led to the pilot chamber 23 is not smaller than the second predetermined pressure, the switching valve 22 is switched to the second communication position 22C. In this case, since the second supply port 33 communicates with the discharge port 34, the operating oil in the back pressure chamber 25 of the operate check valve 21 is led to the control-valve side first main passage 7b through the back pressure passage 31 and is discharged to the tank T from the control valve 6. As a result, a differential pressure is generated before and after the throttle 26a, and the pressure in the back pressure chamber 25 becomes smaller and thus, the force in the valve closing direction acting on the valve body 24 becomes smaller, the valve body 24 is separated from the seat portion 28, and the function of the operate check valve 21 as a check valve is cancelled.

As described above, the operate check valve 21 allows the flow of the operating oil from the control valve 6 to the rod-side chamber 2a, while it is operated to allow the flow of the operating oil from the rod-side chamber 2a to the control valve 6 in accordance with the pressure of the back pressure chamber 25.

When the operate check valve 21 is opened, the operating oil in the rod-side chamber 2a passes through the first main passage 7 and is discharged to the tank T and thus, the cylinder 2 is extended quickly. That is, by switching the switching valve 22 to the second communication position 22C, the flow rate of the operating oil discharged from the rod-side chamber 2a increases and thus, the flow rate of the operating oil supplied to the anti-rod side chamber 2b increases, and the extension speed of the cylinder 2 is quickened. As a result, the arm 1 is quickly lowered to the direction of the arrow 81.

The switching valve 22 is switched to the second communication position 22C when the excavation work or the like is to be performed, and the control valve 6 is largely switched to the extended position 6B. Thus, the pilot pressure led to the pilot chamber 6b of the control valve 6 is large, the pilot pressure led to the pilot chamber 23 of the switching valve 22 becomes not smaller than the second predetermined pressure, and the switching valve 22 is switched to the second communication position 22C.

Subsequently, an action of this embodiment will be described.

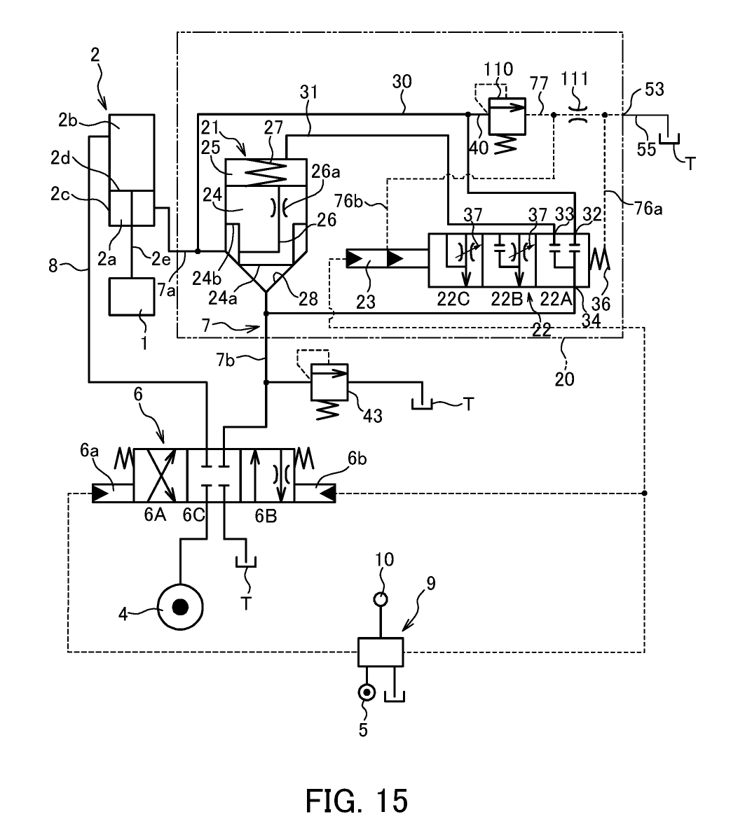

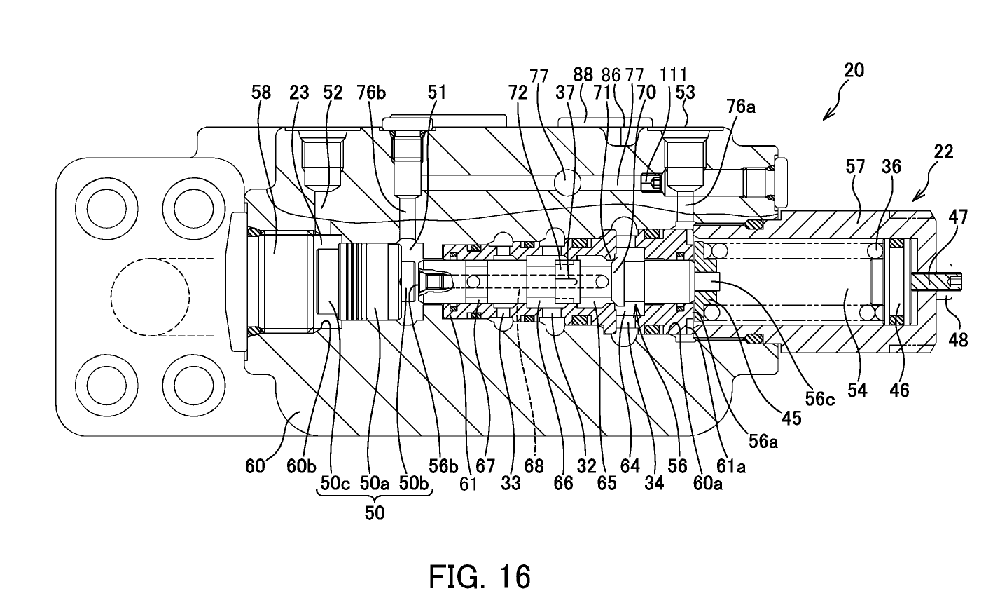

First, by referring to FIGS. 15 and 16, a comparative example of this embodiment will be described. In FIGS. 15 and 16, the same constitutions as in the aforementioned embodiment are given the same reference numerals as in FIGS. 2 to 3. In the comparative example illustrated in FIGS. 15 and 16, a relief valve 110 opened when the pressure in the rod-side chamber 2a reaches a predetermined pressure and allows the operating oil in the rod-side chamber 2a to escape is provided in the relief passage 40. An orifice 111 is provided in the relief discharge passage 77 connecting the relief valve 110 and the tank T. When the pressure in the rod-side chamber 2a reaches the predetermined pressure and the relief valve 110 is opened, the relief pressure oil on the upstream side of the orifice 111 discharged from the relief valve 110 is led to the drain chamber 51 through the second drain passage 76b. As a result, the switching valve 22 is switched to the second communication position 22C, whereby the operate check valve 21 is opened, and the pressure of the operating oil in the rod-side chamber 2a is lowered.

In such comparison, when the pressure in the rod-side chamber 2a increases and the relief valve 110 is opened in a state where the pilot pressure is led to the pilot chamber 23 by the operator's operation so as to move the spool 56 and the cylinder 2 is extended, the relief pressure oil on the upstream side of the orifice 111 discharged from the relief valve 110 is led to the drain chamber 51. The relief back pressure on the upstream side of the orifice 111 led to the drain chamber 51 is larger than the pilot pressure led to the pilot chamber 23 and thus, the piston 50 is moved to the direction separated from the spool 56. Therefore, the thrust of the piston 50 generated by the pilot pressure is not transmitted to the spool 56. Moreover, since the pressure receiving area of the spool 56 on which the pressure of the drain chamber 51 acts is smaller than the pressure receiving area of the piston 50, such a situation can occur that the spool 56 is moved to the closing direction by the biasing force of the spring 36 depending on the intensity of the relief back pressure on the upstream side of the orifice 111 led to the drain chamber 51.

As described above, in the comparative example, if the relief valve 110 is opened during the operation of the operation lever by the operator so as to extend the cylinder 2, the spool 56 is moved to the closing direction, and such a situation can occur that the extending speed of the cylinder 2 intended by the operator cannot be obtained.

On the other hand, in this embodiment, as illustrated in FIGS. 2 and 3, the orifice is not provided in the relief discharge passage 77 connecting the relief valve 41 and the tank T. Therefore, the relief pressure oil discharged from the relief valve 41 is discharged to the tank T through the relief discharge passage 77, and a high pressure does not act on the drain chamber 51. As described above, in this embodiment, even if the relief valve 41 is opened, it does not influence the operation of the switching valve 22, and the relief pressure oil discharged from the relief valve 41 does not operate the switching valve 22. Thus, according to this embodiment, even if the relief valve 41 is opened during the operation of the operation lever by the operator so as to extend the cylinder 2, the spool 56 is not moved to the closing direction, and the extending speed of the cylinder 2 intended by the operator is obtained.

As illustrated in FIG. 2, the relief discharge passage 77 communicates with the second drain port 86 opened in the outer surface of the body 60 through the passage 87. It may be so constituted that the pipeline is connected to the second drain port 86, and the second drain port 86 is connected to the tank T through the pipeline. By constituting as above, the relief pressure oil discharged from the relief valve 41 is discharged to the tank also through the passage 87 and thus, the flow rate of the relief pressure oil led to the drain chamber 51 can be reduced. However, in order to reduce the pipeline connecting the body 60 of the load holding mechanism 20 and the tank T, it is preferable that the pipeline is not connected to the second drain port 86 but the second drain port 86 is sealed by the plug 88 (see FIG. 4). Moreover, it may also be so constituted that the first drain port 53 is sealed by the plug, the pipeline is connected to the second drain port 86, and the relief pressure oil discharged from the relief valve 41 and the drain of the drain chamber 51 and the spring chamber 54 is discharged to the tank T through the second drain port 86.

According to the aforementioned embodiment, the effects shown below are exerted.

The relief pressure oil discharged from the relief valve 41 is discharged to the tank T through the relief discharge passage 77 and the switching valve 22 is not operated and thus, even if the relief valve 41 is opened during the operation of the operation lever by the operator so as to extend and contract the cylinder 2, the spool 56 is not moved to the closing direction, but the extension and contraction speed of the cylinder 2 intended by the operator is obtained. Thus, the stable operation of the cylinder 2 is realized.

Moreover, in this embodiment, the relief pressure oil discharged from the relief valve 41 merges with the drains of the drain chamber 51 and the spring chamber 54 and discharged to the tank T through the first drain port 53 and the pipeline 55. Therefore, since there is no need to provide a pipeline exclusively for leading the relief pressure oil discharged from the relief valve 41 to the tank T, the number of pipelines can be reduced.

Moreover, since the relief pressure oil discharged from the relief valve 41 is discharged to the tank T through the relief discharge passage 77 and is hardly led to the drain chamber 51, even if the relief back pressure is pulsated at opening of the relief valve 41, propagation of the pulsation to the spool 56 is prevented. Therefore, generation of vibration is suppressed.

Moreover, the relief valve 110 in the comparative example for opening the operate check valve 21 by switching the switching valve 22 by the discharged relief pressure oil only needs to lead a pressure enough to switch the spool 56 of the switching valve 22 to the second communication position 22C to the drain chamber 51 and thus, a small-capacity type relief valve with a small discharged flow rate is used. On the other hand, the relief valve 41 in this embodiment needs to have the function of being opened when the pressure of the rod-side chamber 2a reaches the predetermined pressure so as to cause the operating oil in the rod-side chamber 2a to escape to the tank T and to lower the pressure in the rod-side chamber 2a, a large-capacity type relief valve with a discharge flow rate larger than the relief valve 110 in the comparative example is used. As described above, since the relief valve 41 in this embodiment is of a large-capacity type, a degree of design freedom is improved. Moreover, since the relief valve 41 is of a large-capacity type, even if a surge pressure by which the pressure in the rod-side chamber 2a is rapidly raised occurs, the pressure in the rod-side chamber 2a can be kept at the predetermined pressure. Thus, breakage of the cylinder 2 by the surge pressure can be prevented.

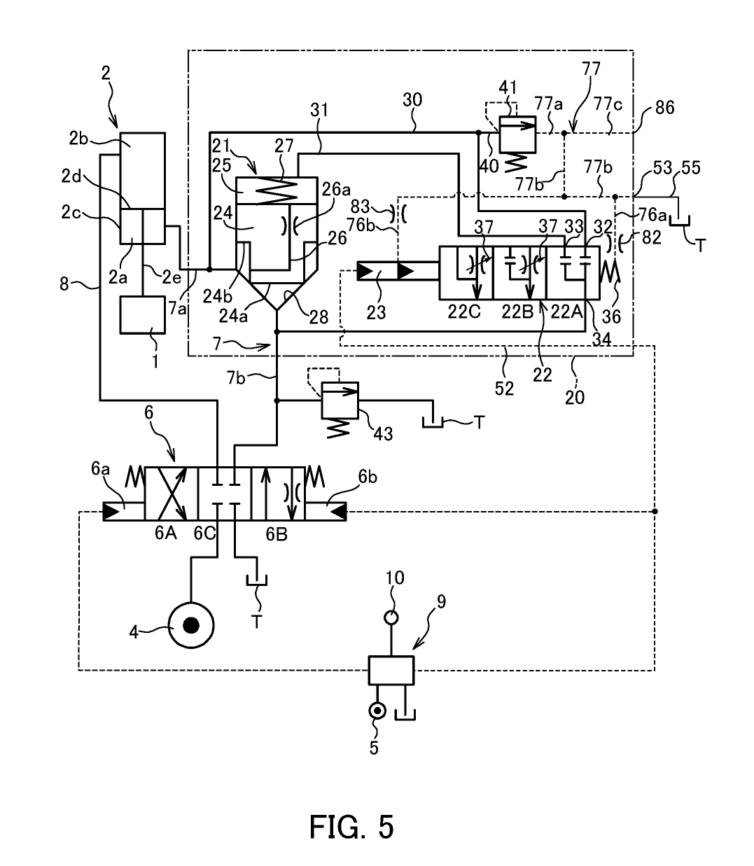

Subsequently, by referring to FIGS. 5 to 8, variations of this embodiment will be described.

In a first variation illustrated in FIG. 5, orifices 82 and 83 as throttles giving resistance to the passing operating oil are provided in each of the first drain passage 76a connected to the spring chamber 54 and the second drain passage 76b connected to the drain chamber 51. By providing the orifices 82 and 83 on each of the first drain passage 76a and the second drain passage 76b, even if the surge pressure is generated in the relief discharge passage 77 at opening of the relief valve 41, propagation of the surge pressure to the spring chamber 54 and the drain chamber 51 can be suppressed. Therefore, malfunction of the spool 56 can be prevented.

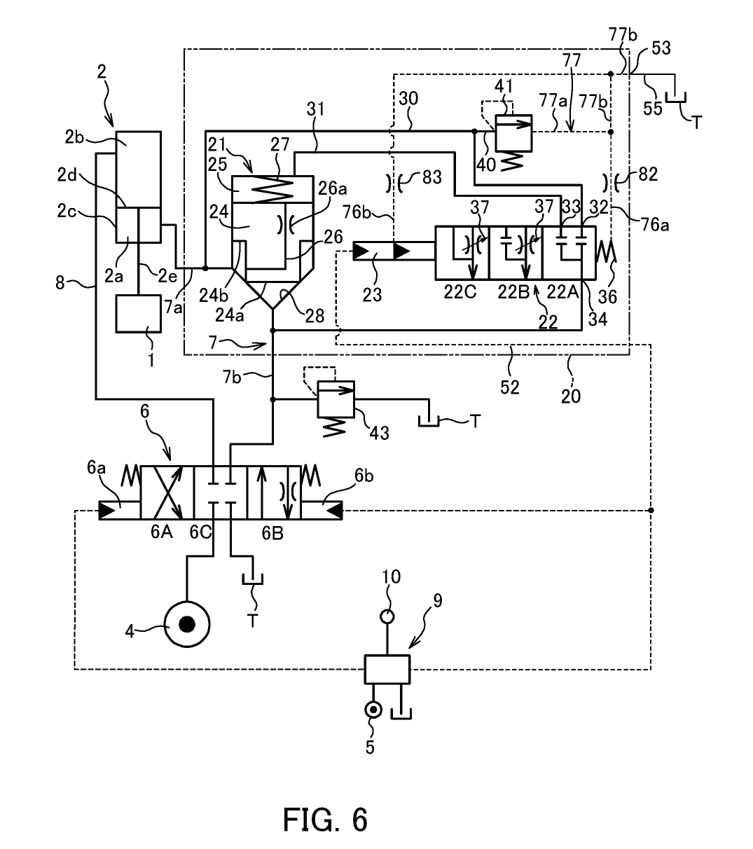

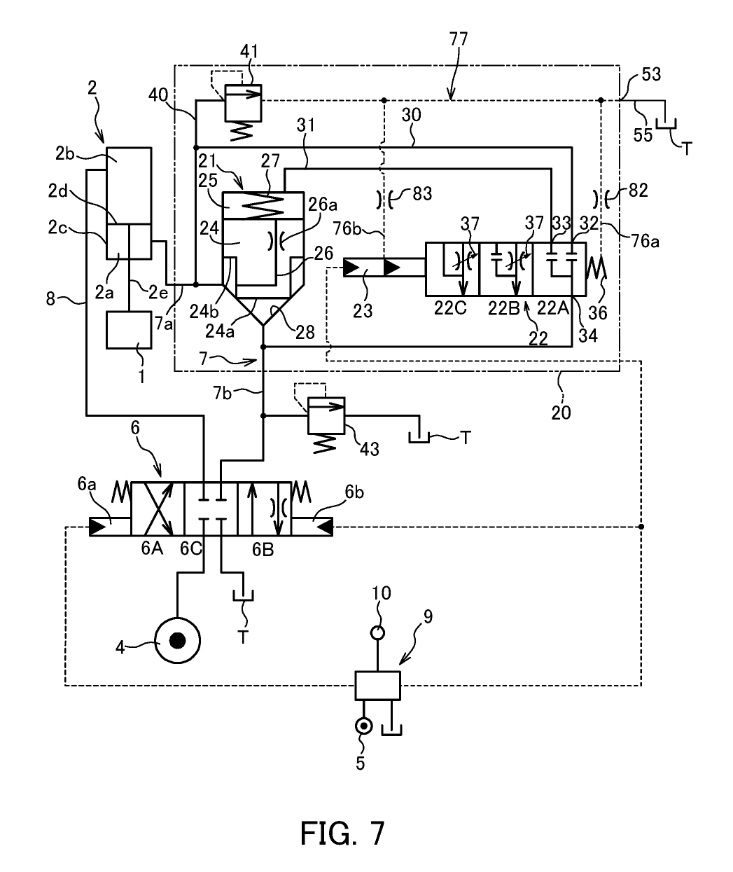

In second and third variations illustrated in FIGS. 6 and 7, connecting methods of the first drain passage 76a and the second drain passage 76b to the relief discharge passage 77 are different from the embodiment illustrated in FIGS. 2 and 5. As described above, the connecting methods of the first drain passage 76a and the second drain passage 76b to the relief discharge passage 77 are not limited to a specific constitution.

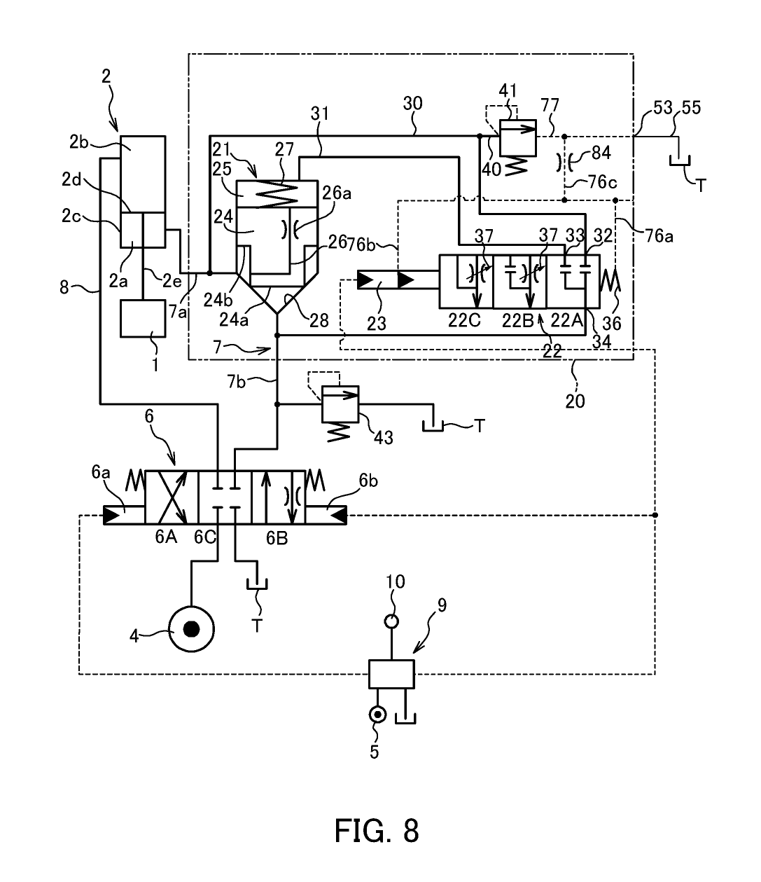

In a fourth variation illustrated in FIG. 8, an orifice 84 as a throttle giving resistance to the passing operating oil is provided in a merging drain passage 76c where the first drain passage 76a and the second drain passage 76b are merged. By constituting as above, the orifice by which propagation of the surge pressure is suppressed can be only one.

### Second Embodiment

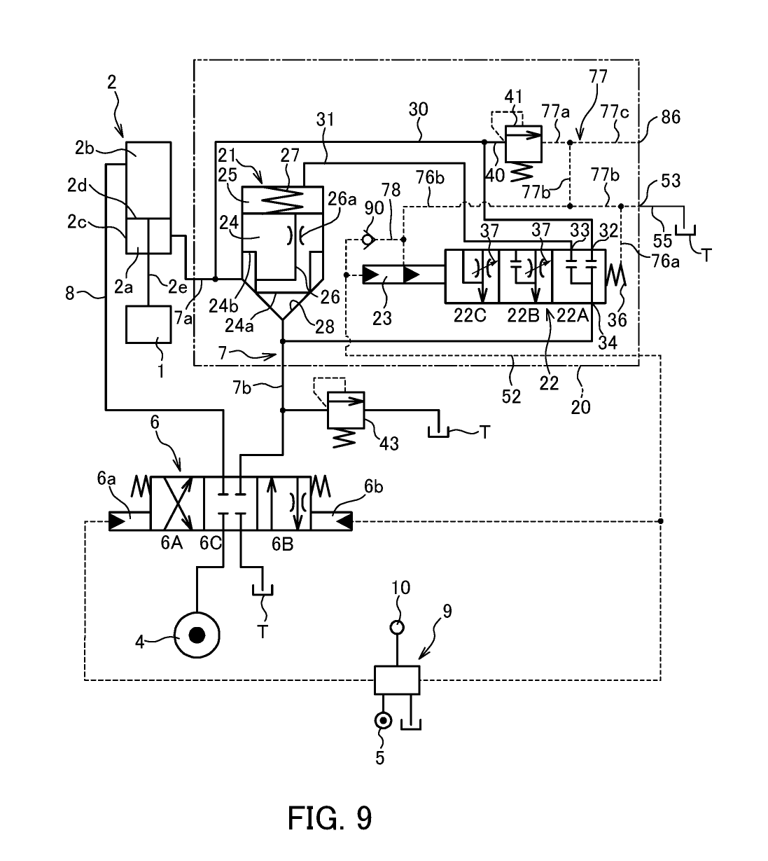

Subsequently, by referring to FIGS. 9 to 11, a hydraulic control device according to a second embodiment of the present invention will be described. In the following, differences from the aforementioned first embodiment will be mainly described, and the same reference numerals are given to the same constitutions as in the hydraulic control device in the aforementioned first embodiment, and explanation will be omitted.

In the hydraulic control device according to the aforementioned first embodiment, the relief pressure oil discharged from the relief valve 41 is discharged to the tank T through the relief discharge passage 77, and a high pressure hardly acts on the drain chamber 51. That is, in the first embodiment, even if the relief valve 41 is opened, it does not influence the operation of the switching valve 22, and the relief pressure oil discharged from the relief valve 41 does not operate the switching valve 22.

However, even in the first embodiment, when the relief valve 41 is opened, it is likely that some relief pressure oil is led to the drain chamber 51 through the second drain passage 76b. The relief pressure oil led to the drain chamber 51 acts to resist the thrust of the piston 50 generated by the pilot pressure.

When an operation amount of the operation lever by the operator is relatively small and the pilot pressure led to the pilot chamber 23 is also relatively small, if the relief valve 41 is opened, it is likely that the relief pressure oil with a pressure larger than the pilot pressure is led to the drain chamber 51. In such a case, it is likely that the piston 50 is pushed back to the direction separated from the spool 56 against the thrust of the pilot pressure by the pressure of the drain chamber 51.

In order to eliminate also the influence of some relief pressure oil led to the drain chamber 51 and to make the operation of the cylinder 2 stable more reliably, in the hydraulic control device according to the second embodiment, as illustrated in FIG. 9, the load holding mechanism 20 further has a connection passage 78 connecting the pilot chamber 23 and the drain chamber 51 and a check valve 90 provided in the connection passage 78 and allowing only the passage of the operating oil from the drain chamber 51 to the pilot chamber 23. In the following, the hydraulic control device according to the second embodiment will be specifically described.

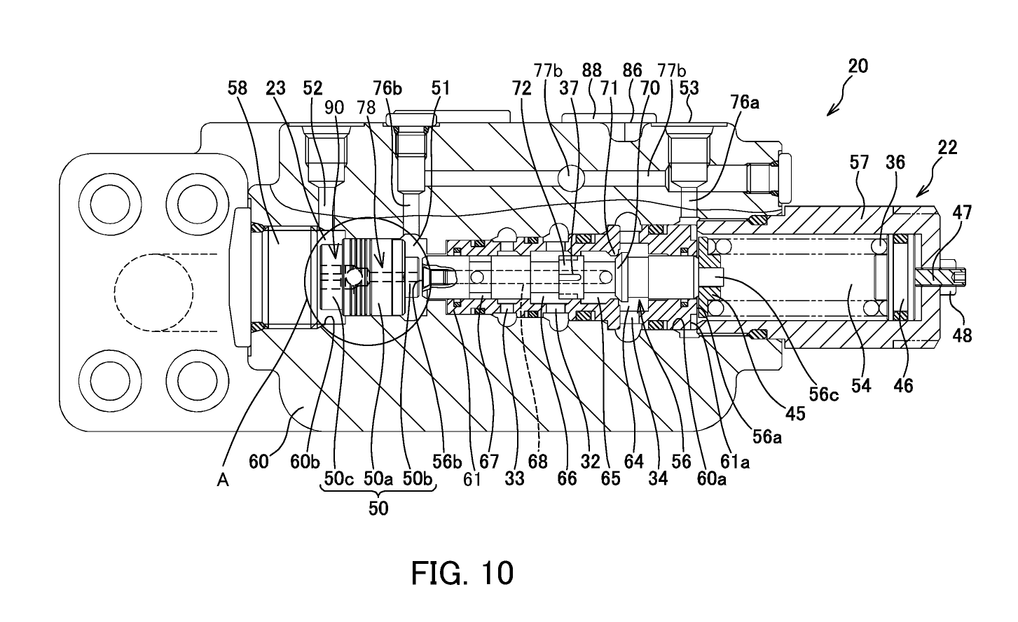

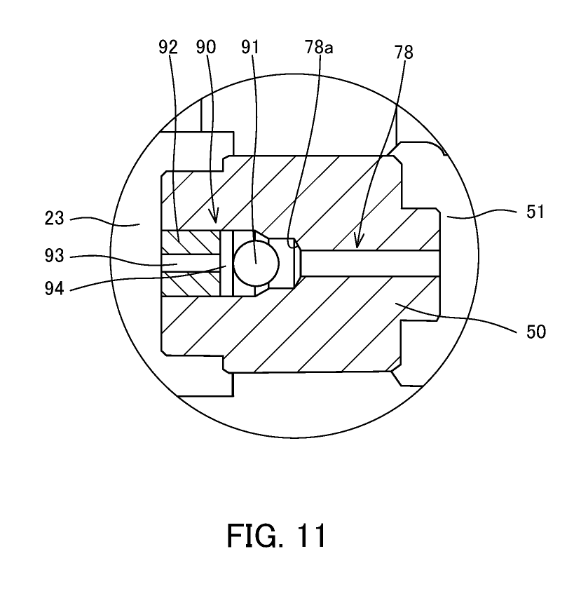

As illustrated in FIGS. 10 and 11, in the second embodiment, the connection passage 78 connecting the drain chamber 51 and the pilot chamber 23 is provided on the piston 50. In the connection passage 78, the check valve 90 allowing only the flow of the operating oil from the drain chamber 51 to the pilot chamber 23 is provided. The piston 50 is formed so that the pressure receiving area receiving the pressure of the drain chamber 51 is equal to the pressure receiving area receiving the pressure of the pilot chamber 23.

The connection passage 78 is formed so as to be opened in the both end surfaces in the axial direction at a shaft core position of the piston 50.

The check valve 90 has a ball 91 separated from and seated on a valve seat 78a formed on the connection passage 78 and a cap member 92 provided on a side opposite to the valve seat 78a with the ball 91 between them.

In the cap member 92, a through hole 93 penetrating in the axial direction and a slit 94 provided by extending in the radial direction in the end surface on the ball 91 side (right side in FIG. 11) so as to communicate with the through hole 93 are formed.

If the pressure of the pilot chamber 23 is larger than the pressure of the drain chamber 51, the check valve 90 is closed. Specifically, the ball 91 is seated on the valve seat 78a, and the communication between the drain chamber 51 and the pilot chamber 23 is shut off. If the pressure of the drain chamber 51 is larger than the pressure of the pilot chamber 23, the check valve 90 is opened (a state illustrated in FIG. 11). Specifically, the ball 91 is separated from the valve seat 78a and is brought into contact with the end surface of the cap member 92, and the operating oil in the drain chamber 51 is led to the pilot chamber 23 through the slit 94 and the through hole 93. Since the check valve 90 is opened as above, the drain chamber 51 and the pilot chamber 23 communicate with each other through the connection passage 78.

In this embodiment, the check valve 90 has a structure not having an biasing member (a spring, for example) for biasing the ball 91 but this is not limiting, and the ball 91 may be urged by the biasing member. The check valve 90 is not limited to the structure illustrated in FIG. 11, and can employ a well-known constitution.

Subsequently, an action of the hydraulic control device according to the second embodiment will be described.

In the second embodiment, too, similarly to the first embodiment, the relief pressure oil discharged from the relief valve 41 is discharged to the tank T through the relief discharge passage 77. Moreover, in this embodiment, the drain chamber 51 and the pilot chamber 23 are connected by the connect passage 78 formed on the piston 50. Thus, even if the relief valve 41 is opened and the relief pressure oil with a pressure larger than the pilot pressure is slightly led to the drain chamber 51, the check valve 90 is opened by the relief pressure oil, and the relief pressure oil is led also to the pilot chamber 23 at the same time. Since the pressure receiving area of the piston 50 receiving the pressure of the drain chamber 51 and the pressure receiving area of the piston 50 receiving the pressure of the pilot chamber 23 are substantially equal to each other, the thrust acting on the piston 50 by the relief pressure oil cancels each other.

Thus, even if the relief valve 41 is opened during the operation of the operation lever by the operator so as to extend the cylinder 2, and the relief pressure oil with a pressure larger than the pilot pressure is led to the drain chamber 51, the piston 50 is not moved by the relief pressure oil. That is, the spool 56 is not moved in the closing direction by the relief fluid, and the switching valve 22 is not operated. As described above, in this embodiment, even if the relief valve 41 is opened during the operation of the operation lever by the operator so as to extend and contract the cylinder 2, the spool 56 is not moved in the closing direction but the extension and contraction speed of the cylinder 2 intended by the operator can be obtained more reliably.

Most of the relief pressure oil discharged from the relief valve 41 is discharged to the tank T through the relief discharge passage 77, and a flow rate led to the drain chamber 51 is small. Thus, the relief pressure oil led to the pilot chamber 23 through the connection passage 78 is not led to the pilot chamber 6b of the control valve 6 and does not influence the operation of the control valve 6.

According to the aforementioned second embodiment, the effects shown below are exerted.

Since the relief pressure oil discharged from the relief valve 41 is discharged to the tank T through the relief discharge passage 77, the relief fluid does not operate the switching valve 22. Moreover, since the pilot chamber 23 and the drain chamber 51 are connected by the connection passage 78, even if the relief pressure oil is led to the drain chamber 51 through the relief discharge passage 77 and the drain passage 76b, the relief pressure oil is led also to the pilot chamber 23 through the connection passage 78 at the same time. As a result, the thrust acting on the piston 50 by the relief pressure oil cancels each other and thus, even if the relief pressure oil is led to the switching valve, the switching valve 22 is not operated. Thus, even if the relief valve 41 is opened during the operation of the operation lever by the operator so as to extend and contract the cylinder 2, the spool 56 is not moved to the closing direction, but the extension and contraction speed of the cylinder 2 intended by the operator is obtained. Therefore, the stable operation of the cylinder 2 is realized more reliably.

Moreover, in this embodiment, the connection passage 78 connecting the drain chamber 51 and the pilot chamber 23 is formed on the piston 50. Thus, machining of the connection passage 78 is facilitated, and space efficiency can be improved.

Subsequently, a variation of this embodiment will be described.

In the aforementioned second embodiment, the connection passage 78 connecting the drain chamber 51 and the pilot chamber 23 is formed on the piston. As a result, even if the relief valve 41 is opened and the relief pressure oil with a pressure higher than the pilot pressure is led to the drain chamber 51, the relief pressure oil is led also to the pilot chamber 23 at the same time. Thus, the thrust acting on the piston 50 by the relief pressure oil is cancelled, and the extension and contraction speed of the cylinder 2 intended by the operator is obtained. On the other hand, the connection passage 78 only needs to connect a pilot line through which the pilot pressure from the pilot control valve 9 is led and a return line through which the relief pressure oil from the relief valve 41 is led. The pilot line includes the pilot passage 52 and the pilot chamber 23. The return line includes the relief discharge passage 77, the first and second drain passages 76a and 76b, and the drain chamber 51. Hereinafter, specific explanation will be given.

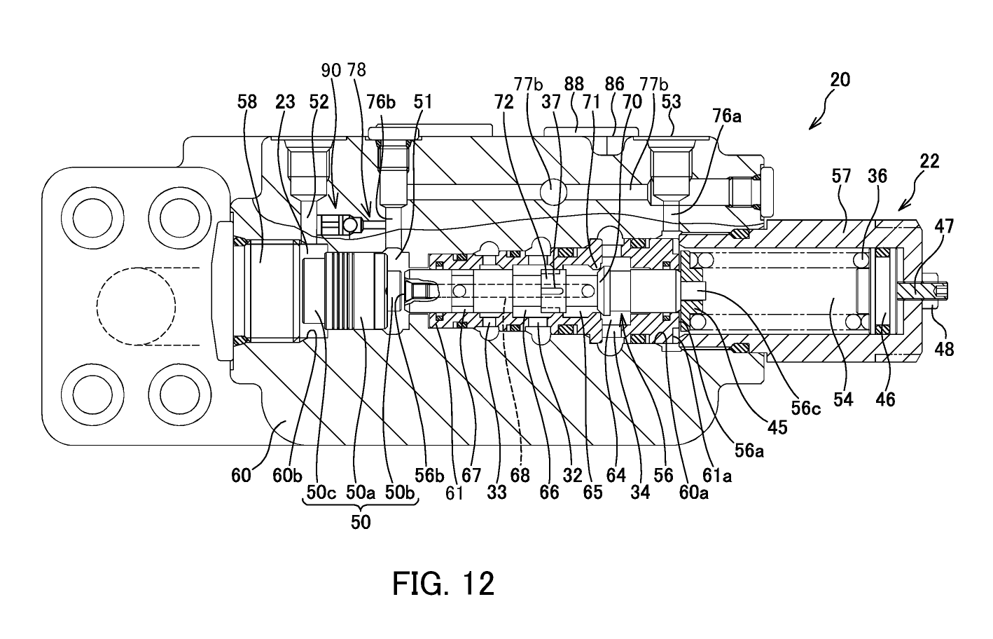

In a fifth variation illustrated in FIG. 12, the connection passage 78 is formed on the body 60 and connects the pilot passage 52 and the second drain passage 76b. In such fifth variation, too, when the relief valve 41 is opened, the relief pressure oil is led to the drain chamber 51 through the second drain passage 76b and is led also to the pilot chamber 23 through the second drain passage 76b, the connection passage 78, and the pilot passage 52 at the same time. Thus, according to the fifth variation, the effect similar to that in the aforementioned second embodiment is exerted.

Moreover, in the aforementioned second embodiment, the pipeline 55 is connected to the first drain port 53, and the first drain port 53 and the tank T are connected through the pipeline 55. On the other hand, it may be so constituted that the first drain port 53 is sealed by the plug, a pipeline 55a is connected to the second drain port 86, and the second drain port 86 and the tank T are connected through the pipeline 55a.

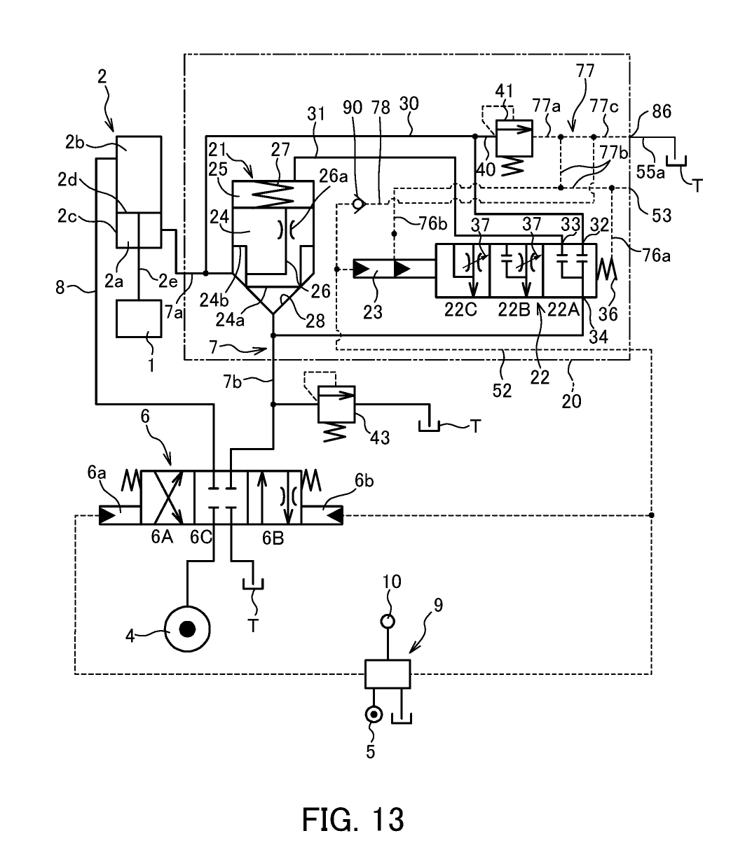

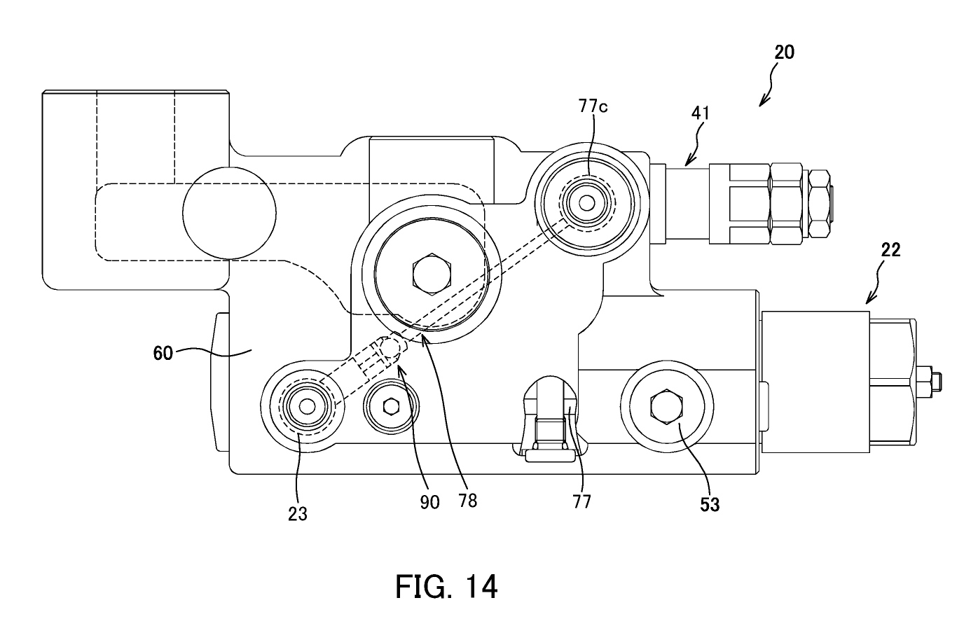

In such a case, as in a sixth variation illustrated in FIGS. 13 and 14, it may be so constituted that the connection passage 78 is formed on the body 60 and connects the second branch passages 77c and the pilot passage 52. As the pipeline 55a connected to the second drain port 86, the one with a diameter larger than the pipeline 55 connected to the first drain port 53 may be connected. Thus, by connecting the pipeline 55a with the relatively large diameter, a cost is increased but channel resistance can be reduced, and intensity of the relief pressure led to the drain chamber 51 can be made smaller. As a result, movement of the spool 56 by the relief pressure oil can be prevented more reliably.

It may also be constituted that the pipeline is connected to both the first drain port 53 and the second drain port 86, and the relief pressure oil is discharged to the tank T also through the first branch passage 77b and the second branch passage 77c. In this case, the connection passage 78 may be connected to the first branch passage 77b or may be connected to the second branch passage 77c. According to this, the flow rate of the relief pressure oil led to the drain chamber 51 can be reduced. However, in order to reduce the pipeline connecting the body 60 of the load holding mechanism 20 and the tank T, as in the aforementioned embodiment, it is preferable that the pipeline is not connected to the second drain port 86 and the second drain port 86 is sealed by the plug 88.

Though not shown, a connection passage connecting any one of the main discharge passage 77a, the first branch passage 77b, and the first drain passage 76b of the relief discharge passage 77 and either one of the pilot chamber 23 and the pilot passage 52 may be provided.

As described above, the connection passage 78 only needs to connect either one of the pilot passage 52 and the pilot chamber 23 constituting the pilot line and any one of the relief discharge passage 77, the first and second drain passages 76a and 76b, and the drain chamber 51 constituting the return line.

The piston 50 is smaller than the body 60 and easy to be machined and other oil passages or the like is not conventionally formed in the piston 50, whereby space efficiency can be improved and thus, the connection passage 78 is preferably formed in the piston 50 as in the aforementioned embodiment.

Moreover, each constitution according to the first to fourth variations of the aforementioned first embodiment may be employed for the fluid pressure control device according to the second embodiment.

Hereinafter, the constitution, actions and effects of the embodiments of the present invention will be described collectively.

In the first and second embodiments, the fluid pressure control device controlling the extending and contracting operation of the cylinder 2 driving the arm 1 includes the control valve 6 adapted to control supply of the operating oil from the pump 4 to the cylinder 2, the pilot control valve 9 controlling the pilot pressure led from the pilot pump 5 to the control valve 6, the main passage 7 connecting the rod-side pressure chamber 2a of the cylinder 2 on which the load pressure by the arm 1 acts when the control valve 6 is at the neutral position 6C and the control valve 6, and the load holding mechanism 20 provided in the main passage 7. The load holding mechanism 20 includes the operate check valve 21 allowing the flow of the operating oil from the control valve 6 to the rod-side pressure chamber 2a while allowing the flow of the operating oil from the rod-side pressure chamber 2a to the control valve 6 in accordance with the back pressure, the switching valve 22 operating in conjunction with the control valve 6 by the pilot pressure led through the pilot control valve 9 and switching the operation of the operate check valve 21, the relief valve 41 opened when the pressure in the rod-side pressure chamber 2a reaches the predetermined pressure, and the relief discharge passage 77 for leading the relief fluid discharged from the relief valve 41 to the tank T. The switching valve 22 includes the pilot chamber 23 to which the pilot pressure is led through the pilot control valve 9, the spool 56 moved in accordance with the pilot pressure of the pilot chamber 23, the spring chamber 54 accommodating the spring 36 biasing the spool 56 to the valve closing direction, the piston 50 giving the thrust against the biasing force of the spring 36 to the spool 56 upon receipt of the pilot pressure on the back surface, the drain chamber 51 defined by the spool 56 and the piston 50, and the drain passages 76a and 76b allowing the drain chamber 51 and the spring chamber 54 to communicate with the relief discharge passage 77. The relief pressure oil discharged from the relief valve 41 is discharged to the tank T through the relief discharge passage 77 and does not operate the switching valve 22.

In this constitution, since the relief pressure oil discharged from the relief valve 41 is discharged to the tank T through the relief discharge passage 77 and does not operate the switching valve 22, even if the relief valve 41 is opened during the operation of the operation lever by the operator so as to extend and contract the cylinder 2, the spool 56 is not moved to the closing direction, but the extension and contraction speed of the cylinder 2 intended by the operator is obtained. Thus, the stable operation of the cylinder 2 is realized.

Moreover, in the first and second embodiments, the throttles 82 and 83 for giving resistance to the passing operating oil are provided in the drain passages 76a and 76b.

In this constitution, even if the surge pressure is generated in the relief discharge passage 77 at opening of the relief valve 41, propagation of the surge pressure to the spring chamber 54 and the drain chamber 51 can be suppressed. Therefore, malfunction of the spool 56 can be prevented.

Moreover, in the first and second embodiments, the relief valve 41 has a discharge flow rate larger than that in the case where the switching valve 22 is switched by the discharged relief pressure oil so as to open the operate check valve 21.

In this constitution, since the relief valve 41 is of a large-capacity type with a large discharge flow rate, a degree of design freedom is improved.

Moreover, in the second embodiment, the pilot line is constituted by the pilot passage 52 and the pilot chamber 23, the return line is constituted by the relief discharge passage 77, the drain chamber 51, and the first and second drain passages 76a and 76b, and the load holding mechanism 20 further includes the connection passage 78 connecting the pilot line and the return line and the check valve 90 provided in the connection passage 78 and allowing only the passage of the operating oil from the return line to the pilot line.

In this constitution, since the relief pressure oil discharged from the relief valve 41 is discharged to the tank T through the relief discharge passage 77, the relief pressure oil does not operate the switching valve 22. Moreover, since the pilot line and the return line communicate with each other by the connection passage 78, even if the relief pressure oil is led to the drain chamber 51 of the switching valve 22 through the relief discharge passage 77 and the drain passage 76b, the relief pressure oil is led also to the pilot chamber 23 through the connection passage 78 at the same time. As a result, since the thrust acting on the piston 50 by the relief pressure oil cancels each other, the relief pressure oil does not influence the operation of the switching valve 22. Thus, even if the relief valve 41 is opened during the operation of the operation lever by the operator so as to extend and contract the cylinder 2, the spool 56 is not moved to the closing direction, but the extension and contraction speed of the cylinder 2 intended by the operator is obtained. Therefore, the stable operation of the cylinder 2 is realized.

Moreover, in the second embodiment, the connection passage 78 is formed in the piston 50 and connects the drain chamber 51 and the pilot chamber 23.

According to this constitution, machining of the connection passage 78 is facilitated, and space efficiency can be improved.

Moreover, in the second embodiment, the connection passage 78 may connect the relief discharge passage 77 and the pilot passage 52.

Moreover, in the second embodiment, the connection passage 78 may connect the drain passage 76b and the pilot passage 52.

The embodiments of the present invention described above are merely illustration of some application examples of the present invention and not of the nature to limit the technical scope of the present invention to the specific constructions of the above embodiments.

The present application claims a priority based on Japanese Patent Application No. 2015-188453 filed with the Japan Patent Office on Sep. 25, 2015 and Japanese Patent Application No. 2016-153158 filed with the Japan Patent Office on Aug. 3, 2016, all the contents of which are hereby incorporated by reference.

1. A fluid pressure control device for controlling an extension and contraction operation of a cylinder driving a load, comprising:
a control valve configured to control supply of an operating fluid from a fluid pressure supply source to the cylinder;
a pilot control valve configured to control a pilot pressure led from a pilot pressure supply source to the control valve;
a main passage connecting a load-side pressure chamber of the cylinder on which a load pressure by a load acts when the control valve is at a neutral position and the control valve; and
a load holding mechanism provided in the main passage, wherein
the load holding mechanism includes:
an operate check valve configured to allow a flow of the operating fluid from the control valve to the load-side pressure chamber, while allow the flow of the operating fluid from the load-side pressure chamber to the control valve in accordance with a back pressure;
a switching valve configured to be operated in conjunction with the control valve by the pilot pressure led through the pilot control valve so as to switch an operation of the operate check valve;
a relief valve configured to open when a pressure in the load-side pressure chamber reaches a predetermined pressure; and
a relief discharge passage configured to lead a relief fluid discharged from the relief valve to a tank,
the switching valve includes:
a pilot chamber to which the pilot pressure is led through the pilot control valve;
a spool moved in accordance with the pilot pressure of the pilot chamber;
a spring chamber accommodating an biasing member biasing the spool in a valve closing direction;
a piston giving thrust against an biasing force of the biasing member to the spool upon receipt of the pilot pressure on a back surface;
a drain chamber defined by the spool and the piston; and
a drain passage configured to allow the drain chamber and the spring chamber to communicate with the relief discharge passage, and
the relief fluid discharged from the relief valve is discharged to the tank through the relief discharge passage and does not operate the switching valve.

2. The fluid pressure control device according to claim 1, wherein
a throttle giving resistance to a passing fluid is provided in the drain passage.

3. The fluid pressure control device according to claim 1, wherein
the relief valve has a discharge flow rate larger than a case where the switching valve is switched by a discharged relief fluid and the operate check valve is opened.

4. The fluid pressure control device according to claim 1, wherein
a pilot line is constituted by a pilot passage adapted to lead a pilot pressure to the pilot chamber and the pilot chamber;
a return line is constituted by the relief discharge passage, the drain chamber, and the drain passage; and
the load holding mechanism further includes a connection passage connecting the pilot line and the return line and a check valve provided in the connection passage and allowing only passage of the operating fluid from the return line to the pilot line.

5. The fluid pressure control device according to claim 4, wherein
the connection passage is formed in the piston and connects the drain chamber and the pilot chamber.

6. The fluid pressure control device according to claim 4, wherein
the connection passage connects the relief discharge passage and the pilot passage.

7. The fluid pressure control device according to claim 4, wherein
the connection passage connects the drain passage and the pilot passage.
